(19) United States
(12) Patent Application Publication
(10) Pub. No.: US 2025/0187823 A1
(43) Pub. Date: Jun. 12, 2025

(54) RACK OPERATING DEVICE, RACKING SYSTEM AND METHOD FOR ASSEMBLING A RACKING SYSTEM

(71) Applicant: Gebhardt Foerdertechnik GmbH, Sinsheim (DE)

(72) Inventors: Marco Gebhardt, Sinsheim (DE); Michael Auer, Bad Rappenau (DE); Jürgen Nosch, Feldkirch (AT)

(21) Appl. No.: 18/970,510

(22) Filed: Dec. 5, 2024

(30) Foreign Application Priority Data
Dec. 6, 2023 (DE) 10 2023 212 313.4

(51) Int. Cl. B65G 1/04

(52) U.S. Cl. CPC B65G 1/0414

(57) ABSTRACT

With a view to improving access to parts of a racking system using structurally simple means, a rack operating device for the racking system, in particular for a storage and retrieval system, is specified. The rack operating device has at least one mast extending in the vertical direction and a lifting unit movably arranged on the mast. The rack operating device is designed and developed wherein the mast is arranged directly on a rack upright of the rack system and/or is integrated into the rack upright. A specified racking system is designed accordingly. A method for assembling the racking system is specified.

### BACKGROUND

### Technical Field

The disclosure relates to a rack operating device for a racking system, in particular for a storage and retrieval system, wherein the rack operating device has at least one mast extending in the vertical direction and a lifting unit movably arranged on the mast.

The disclosure further relates to a racking system, in particular a storage and retrieval system, with a rack storage unit with at least one storage rack, wherein the at least one storage rack has one or more compartments for a stored item in one rack level or in a plurality of rack levels lying one above the other, and with at least one rack operating device

The disclosure further relates to a method for assembling a racking system.

### Description of the Related Art

Rack operating devices or also lifts of the type in question have been known in practice for years and serve for accessing the goods in a racking system, in particular in a storage and retrieval system similar to a high-bay warehouse.

Known rack operating devices are located in front of the respective storage rack or in a rack aisle formed between two storage racks. In this context, the arrangement of the rack operating devices is crucial to achieving the necessary throughput of goods in the racking system. The rack operating devices are arranged in front of/next to/between the storage racks and at a distance from the storage racks.

Such rack operating devices have at least one mast extending in a vertical direction and a lifting unit movably arranged on the mast for transporting storage goods. The rack operating device can thus transport stored goods in a vertical direction using the lifting unit and can place them in, or remove them from, racking systems. All types of pallets, containers, trays, and boxes can be used as load carriers for the stored or conveyed goods. This also includes all load carriers that are used, for example, in supermarkets—for example, a package with six bottles of barbecue sauce that has only a cardboard “tray” on the bottom and is film-wrapped/shrink-wrapped. Envelopes and/or polybags—for example, containing textile goods—can also be considered as stored goods.

However, with known rack operating devices, safe access is problematic in the event of a fault since the mast to a certain extent blocks access to the lifting unit.

### BRIEF SUMMARY AND GENERAL DESCRIPTION

The present disclosure is therefore based on an object of designing and developing a rack operating device as well as a corresponding racking system in such a way that with structurally simple means better access to the parts of the racking system is ensured. A space-saving, inexpensive and access-optimized alternative is to be created. Furthermore, an efficient and simplified method for assembling the racking system is to be specified, which ensures fast, inexpensive and easy assembly of the rack operating device.

According to an embodiment of the disclosure, the rack operating device is characterized in that the mast is arranged directly on a rack upright of the racking system and/or is integrated into the rack upright.

In accordance with the disclosure, it has been recognized that the underlying problem can be solved by a clever design of the mast or masts. Specifically, the masts are arranged directly on the rack uprights and/or “replace” the rack uprights when integrated and are thus integrated into the storage rack. The mast can be attached and/or fastened directly or indirectly to the rack upright, or can be integrally formed with the rack upright, or can replace the rack upright.

This means that the masts are not “in the way” or in the rack aisles, as is the case with conventional rack operating devices. The masts hinder access to the individual rack operating device or lifts much less.

A rack operating device is thereby proposed that with simple structural means ensures better access to the parts of the racking system. The rack operating device offers a space-saving, inexpensive and access-optimized alternative.

The cross-section of the mast has a profile that enables it to do the job of a rack upright and at the same time that of a lifting mast. An increased geometrical moment of inertia compared to a known rack upright prevents overloading (stability failure, failure due to excessive stresses) when loaded with moments from the lifting unit or static loads from goods stored in the rack. Unlike known rack uprights, masts are suitable and optimized for the introduction of torque over the entire length of the mast at any position of a lifting unit. In contrast, rack uprights are only optimized for pressure loads—in the vertical direction—and are less suitable for the introduction of moments that occur when operating the rack operating device with the lifting unit. The masts can, for example, be aluminum and/or be made of an aluminum alloy, but have a high geometrical moment of inertia and a much larger cross-section and therefore a larger section modulus than a rack upright, even if the rack upright is made of steel. Even known rack uprights with a mast designed as a guide rail or, in other words, with an elevator rail that is screwed to or on the rack upright or is attached in front of or on the rack upright, may not have a sufficient geometrical moment of inertia depending on the design, although there is additional assembly work. For this reason, known rack uprights cannot be used as masts or can only be used to a limited extent. When known rack uprights are used, dimensional tolerances in the storage rack change too much during loading and/or even during assembly so that the adjustments made are not reproducible. Alternatively, the masts can also comprise steel and/or be designed as tubes.

FEM 9.831 is a standard for the use of rack operating devices in high-bay warehouses. For adjacent uprights on the same storage rack, FEM 9.831 permits a tolerance of +/−15 mm in the horizontal x-direction along the storage rack. However, a tolerance of +/−0.8-1.0 mm is preferred. For the individual field length, FEM 9.831 permits a tolerance of +/−3 mm in the x-direction. On the one hand, permissible tolerances based on standards for the storage rack must be taken into account, as well as on the other hand tolerances that are technically necessary for the functioning of the lifting unit. Known racking systems permit a tolerance on the rack uprights of approx. +/−5 mm.

If the masts are attached in front of the rack uprights or directly on the rack uprights, the fastening to the rack uprights will be adjustable so that adjustment of the masts becomes independent of the rack tolerances. However, separate rack uprights are required.

If the masts “replace” the rack uprights and are integrated into the rack uprights or the storage rack, no separate rack upright is required. An expensive and complex separate mast structure with connecting brackets on the masts is also unnecessary. The masts are aligned with the storage rack, and additional alignment of the mast structure relative to the storage rack is therefore unnecessary. The number of components in the overall system is reduced, and assembly time can be saved. In addition, the space requirement is reduced.

With regard to a particularly simple design and advantageous kinematics of the rack operating device, each lifting unit can be arranged on two masts so that it can move in the vertical direction.

According to one embodiment, each lifting unit can be assigned two separate masts which are preferably located laterally in an x-direction to the left and right of the lifting unit, in other words to the left and right from the perspective of an observer standing in front of the storage rack. A right-hand mast of a first lifting unit located on the left can be arranged directly next to a left-hand mast of a second lifting unit located on the right. Each lifting unit therefore has its own two mast profiles so that each rack operating device is modular and individually adjustable. However, a larger number of masts is required and the space requirement is increased.

Preferably, two lifting units arranged next to each other to the left and right share the mast arranged between them. The mast is thus used by lifting units/lifting cages on both sides. This reduces the overall number of masts and the space required. Assembly time can also be saved.

According to one embodiment of the rack operating device, a drive device can move the lifting unit on the mast via at least one suspension means extending in the vertical y-direction, preferably in the vertical upward and/or downward direction. The suspension means can, for example, be designed as a belt.

The drive device can, for example, be arranged centrally below the lifting unit. In this case, the space required for the drive or a motor of the drive device in the z-direction—i.e., in the horizontal direction into the storage rack or out of the storage rack and into the rack aisle—is minimized. The drive is easily accessible with regard to maintenance and adjustments. For safety reasons, it is possible to unplug one shaft of the motor from an adjacent rack operating device and/or to therefore disconnect it from the power supply. In addition, safety of operation can be increased by having two suspension means-one to the left and one to the right of the drive. However, this variant results in a relatively large lower approach dimension. The lower approach dimension is the lowest position in the vertical y-direction that the lifting unit of the rack operating device can reach due to its design. Since the drive device occupies the space at the foot of the mast, the lifting unit cannot be lowered all the way to the ground. A disadvantage of a comparatively large lower approach dimension is that the storage capacity decreases because there is overall less space available for rack levels—for example, in the warehouse.

As a variant, the drive device can be located outside the storage rack in the z-direction—i.e., in the rack aisle if necessary. In other words, the drive device is located behind the lifting unit. This makes the drive device and all its components particularly easy to access, and the lower approach dimension is reduced considerably. For safety reasons, the shaft can be disconnected from the front. Moreover, safety of operation can be increased by having two suspension means-one to the left and one to the right of the drive. However, the space required in the z-direction for the drive device and the motor increases. The components are “in the way” or in the rack aisle.

As a further variant, the drive device can be arranged in the storage rack in the z-direction or, in other words, in front of the lifting unit or below the storage rack. This results in a small space requirement in the z-direction and in a moderate lower approach dimension for the lifting unit. Safety of operation can be increased by having two suspension means-one to the left and one to the right of the drive. However, the drive device is less easily accessible when located below the storage rack.

According to a particularly advantageous development, the drive device can be designed as a drive console for particularly good accessibility, which can be pulled like a drawer into the rack aisle or in the direction of an access area. A particularly rigid construction is advantageous.

As a further variant, the drive device can be located laterally next to the lifting unit in the x-direction. This variant offers advantageous accessibility to the drive unit and advantageous space requirements. The drive unit has only one belt thickness/width in the x-direction, while the previously described variants require twice the belt width. In terms of safety of operation, one lateral drive device can also drive only a single lateral suspension means. The motor size is limited.

According to a further embodiment, two drive devices can also be provided per lifting unit, which are located in the x-direction on both sides next to the lifting unit—in other words, to the left and right of the lifting unit. This design is advantageous in terms of safety, because the lifting unit can be equipped with two suspension means and/or brakes. The brakes can also be assigned directly or indirectly to the drive device. However, a larger approach dimension results if motors are partially arranged below the lifting unit. In addition, an electronic synchronization of the two drive devices must be ensured.

As a further variant, the drive device can also be arranged at the top of the mast head.

With regard to a stable construction, the lifting unit can be fixed to the mast with one degree of freedom in the vertical direction. Since the mast is located directly on the storage rack, the pivot point of the lifting unit is also located directly on the storage rack so that the torque around the x-axis caused by the lifting unit and/or stored goods is reduced. This makes possible a lightweight construction of the mechanics and smaller drives in the drive devices.

With regard to the usability of smaller motors or drive devices, a counterweight designed for the lifting unit can also be provided and, if necessary, brought into engagement with the suspension means, for example if the drive device(s) is/are located to the side of the lifting unit.

The lifting unit can have a lifting cage with guide elements for connection to the mast. The guide elements can define the degree of freedom in the vertical direction and can be designed as rollers, for example. According to another embodiment, the guide elements can be designed as linear rails. The lifting cage can have aluminum profiles for inexpensive production and weight reduction. Alternatively or additionally, the lifting cage could be designed so as to include thin sheets, preferably metal sheets, or composite materials.

The lifting unit can further carry at least one load-handling device which can be moved horizontally in the lifting unit. In particular, the load-handling device can be movable in the lifting cage. The load-handling device can be designed as a module including push-out drive and guide rails. Optionally, the push-out drive can be designed to be pluggable at the rear—i.e., in the z-direction away from the storage rack-so that the push-out drive can be quickly replaced without removing the load-handling device.

The load-handling device can be mounted in a floating manner and can be centered on the rack with an extension movement if necessary.

The load-handling device can have tines that enable the load-handling device to grip many different conveyed and/or stored goods from below. This can be advantageous in particular for goods with very heterogencous packaging—for example, supermarket goods.

In order to advantageously centralize the electrical components, the load-handling device can include sensors for the horizontal axis and/or vertical axis. If, as described above, two lifting units arranged next to each other to the left and right share the mast arranged between them, the two lifting units or both rack operating devices can only be adjusted together. The load-handling device can preferably be individually adjustable relative to the lifting cage via adjusting screws—i.e., independently of the lifts/masts. In other words, wherever possible, the load-handling device is adjusted instead of the masts.

Preferably, the electrical system/electronics can also be centralized with a view to improved mounting options since there is hardly any space on the mast for the sensor system and wiring. This eliminates the need for complex wiring on the mast. Preferably, all the electronics can be exchanged with the load-handling device. Another possible advantage is that an energy chain is attached to the load-handling device and the rack, and not to the load-handling device and the mast/lift. This prevents any damage to the electronics on the mast by the rack builder.

According to a particular embodiment, the rack operating device can have two drive devices for two lifting units, each with a load-handling device. This significantly increases the throughput in the racking system. The two drive devices can be arranged, for example, by combining two different drive positions—in the z-direction “behind”, “under” and/or “in front of” the lifting unit with the respective load-handling device. There can be two belts on the sides of the lifting cages for each drive.

According to a first alternative, both load-handling devices can be permanently assigned to a defined region of the storage rack. This simplifies control. It is impossible for the two load-handling devices to get in each other's way. In addition, an “emergency mode” can be set up in which—for example by switching in the control system-a load-handling device can, as an exception, nevertheless serve the region of the storage rack that is actually permanently assigned to and reserved for the other load-handling device. In emergency mode, throughput is then lower.

According to a second alternative, a dynamic assignment of regions of the storage rack to the load-handling devices is also possible. Here the two load-handling devices move to all positions that they can geometrically reach. Naturally, the lower load-handling device cannot move all the way down, and the upper load-handling device cannot move all the way up because in each case the other load-handling device is in the way. With dynamic assignment, an even higher throughput is possible due to the constant redundancy. However, control and regulation is more complex, and a malfunction, in the worst case a collision of the two load-handling devices, results in significant damage.

According to a further particular embodiment, the rack operating device can have two load-handling devices in the same lifting unit or in the same lifting cage. The load-handling devices can preferably be arranged one above the other in the same lifting cage. A single drive device can be sufficient. However, due to the greater weight of the lifting unit with the two load-handling devices, this drive device is larger. This can have an impact on the rack grid in the x-direction and/or on the lower approach dimension of the lifting unit.

A height grid of the load-handling devices can preferably correspond to a height grid of the storage rack so that simultaneous operation, i.e., loading/unloading of conveyed/storage goods, is possible in two vertically adjacent rack levels. This measure also increases throughput in the racking system.

It is also possible to telescope the two load-handling devices individually and independently of each other, which can also increase throughput. For example, this could be achieved by providing separate horizontal axes.

With regard to an improved racking system, a racking system, in particular a storage and retrieval system, with a rack storage unit with at least one storage rack is proposed. The at least one storage rack has one or more compartments for conveyed/storage goods in one rack level or in a plurality of rack levels arranged one above the other. The racking system has at least one rack operating device according to the disclosure.

With regard to increased dimensional accuracy and the ability to maintain smaller tolerances as well as increased dimensional stability, at least two masts in the racking system can be connected by at least one cross strut extending in the horizontal direction. In other words, the cross strut extends in the x-direction.

The two masts do not necessarily have to be two masts that are assigned to the same lifting unit as described above. The cross strut or cross struts can also connect and brace more than two masts. The masts in the x-direction can preferably—but not necessarily—have the same division as the compartments of the storage rack and/or—if the masts do not replace the rack uprights—have the same division as the rack uprights. According to one embodiment, the cross strut can also connect two rack uprights of the racking system, each of which has a mast directly arranged thereon.

Preferably, the cross strut can simultaneously support one or more rack uprights for one or more compartments of the racking system. As explained above, the deformation of the storage rack during operation depends on the load. It is therefore advantageous to technically limit deformation at interfaces between automation and storage rack. One possible measure for this is by means of cross struts to attach the rack uprights to the lift mast or to the mast of the rack operating device. This means that the rack uprights can only deform/shift slightly relative to the rack operating device.

The tines of the load-handling device can preferably fit into the rack uprights, wherein a tolerance of +/−1.5 mm should be maintained.

In this example, the cross struts for the rack uprights are attached to or in front of the masts. This means that the rack operating devices form a network. In addition, the masts can be doweled to the ground and set in cement to improve bracing and to avoid a “parallelogram effect”. Because the cross struts for the rack uprights are attached to the masts, the alignment of the position of the load-handling device to the rack upright for the storage or conveyed goods in the storage rack can be fixed in relation to each other.

According to one possible embodiment, a plurality of cross struts arranged one above the other can define said plurality of stacked rack levels.

Further bracing of the storage rack can be achieved if the masts-insofar as they do not replace the rack uprights—are arranged in the x-direction in the same grid as the rack uprights.

Easy alignment of the lift masts is also possible if the masts are part of the storage rack. The cross struts and, if applicable, the profiles of the support brackets connect the masts to form a network.

The cross struts can connect the masts to the masts of the other-preferably neighboring-cells or storage racks. Alternatively or additionally, the bracing can also be improved by structures, other shelving elements, platforms and/or other auxiliary structures. This allows the storage rack and rack operating device to be braced.

Thanks to the improved mast position, the masts are arranged directly on the storage rack and do not get in the way. The rack operating devices are therefore easily accessible. Furthermore, the use of advanced camera and/or sensor systems is made possible. Cameras need a large field of view to replace the sensor systems that are currently used. A camera must be able to be positioned so that it can see all relevant regions. With a corresponding field of view, a camera can detect conveyed goods/storage goods and/or clearances and/or errors.

According to a preferred development, the mast heads of two masts arranged next to each other can be connected to each other by a cross strut. Such a cross strut can also be called a crossbeam. The crossbeam also serves for bracing. The crossbeam can preferably be made of angled sheet metal.

The upper mast section can be adjusted overall in the y-direction to the rack height. The rack height often depends on the building.

In the variant described above in which the drive device is arranged at the top of the mast head, the crossbeam can also be a cover for the drive device.

With a view to further improving the bracing, the rack storage unit can have two opposing storage racks, wherein a rack aisle is formed between the storage racks, wherein two masts of the two storage racks opposite each other across the rack aisle are connected to each other by means of at least one bracing element. In other words, the bracing extends in the z-direction.

According to an optimized arrangement, at least three or more rack operating devices are provided per storage rack not only in order to optimally use the racking network but also to be able to optimally install the rack operating devices.

A method for assembling a racking system as described herein comprises the following steps:
a) mounting the at least one mast when setting up the rack storage unit with at least one storage rack,
b) checking dimensional accuracy and/or compliance with tolerances,
c) mounting the lifting unit(s) of the racking system and preferably the drive device(s) and/or load-handling devices, and
d) wiring and preferably installing the sensor system.

In known methods for assembling racking systems, lifts or rack operating devices including two masts, for example ten meters high, are delivered in one piece. This results in a large amount of space being required, not only during assembly but also for intermediate storage. For safety reasons, it is not possible to remain in the immediate vicinity while the lift is being erected since the lift could fall.

Preferably, therefore, according to the method according to the disclosure, the lifting cage can be installed and adjusted by hand-without aids—or with hand tools/light equipment on the mast or between the masts after the masts have been provided during rack assembly—for example as part of the storage rack. Preferably, the suspension means can be threaded in via ladders, which can be attached to the bracing, for example. In the context of wiring, an energy chain can be attached to the bracing elements—also by way of example—whereby here too access can be made possible via the ladders. One advantage here is that the energy chain is detached from the mast/lift so that no energy chain guide is required. The ladders could also be arranged at the front of the mast.

In the context of the construction of the rack storage unit in step a), the mast head with the crossbeam and/or the bracing can also be installed as described, as well as other components that are required for dimensionally accurate assembly.

In the context of the mechanical assembly of the lifting unit in step c), additional assemblies can be installed in addition to the lifting unit, if necessary with the load-handling device. This makes possible improved processes on construction sites since the lifts no longer have to be transported as a whole, and downstream sections of the plant can therefore start earlier with their activities. The parts to be moved are smaller and less critical in terms of occupational safety. It will also be possible to mount maintenance platforms or conveyors in front of the rack and only then add the remaining components.

This provides an efficient and simplified method for assembling the racking system, which ensures fast, inexpensive and easy installation of the rack operating device.

### BRIEF DESCRIPTION OF THE SEVERAL VIEWS OF THE DRAWINGS

There are various possibilities for designing and developing the teaching of the present disclosure in an advantageous manner. To this end, reference is made to the following explanation of preferred exemplary embodiments of the disclosure based upon the drawings. In connection with the explanation of the preferred exemplary embodiments of the disclosure based upon the drawings, generally preferred embodiments and developments of the teaching are also explained. In the drawings:

FIG. 1 shows a top view from above of a racking system with rack operating devices according to the prior art,

FIG. 2 shows a perspective view of an embodiment of the rack operating device according to the disclosure and of the racking system with integrated masts,

FIG. 3 shows a sectional view from above of a conventional rack upright and a mast,

FIG. 4 shows in a perspective view of the conventional rack upright and the mast from FIG. 3,

FIG. 5 shows another perspective view of the embodiment of the rack operating device according to the disclosure and of the racking system from FIG. 2,

FIG. 6 shows a perspective view of a storage rack according to the embodiment from FIG. 2,

FIG. 7 shows a perspective view of a storage rack according to another embodiment,

FIG. 8 shows a top view of a mast with a split profile between two lifting units,

FIG. 9 shows a perspective view of a drive device which is arranged behind the lifting unit according to the embodiment from FIG. 2,

FIG. 10 shows a perspective view of a drive device according to another embodiment, which is arranged in front of the lifting unit

FIG. 11 shows a perspective view of a drive device according to another embodiment, which is arranged below the lifting unit,

FIG. 12 shows a top view from above of another embodiment of the racking system with a drive unit that is arranged laterally next to the lifting unit,

FIG. 13 shows a top view from above of another embodiment of the racking systems with two drive units that are arranged laterally next to the lifting unit,

FIG. 14 shows a side view of a lifting unit of a rack operating device according to the prior art,

FIG. 15 shows a side view of a lifting unit of the rack operating device according to the disclosure,

FIG. 16 shows a perspective view of two embodiments of lifting cages for lifting units of the rack operating device according to the disclosure,

FIG. 17 shows a perspective view of a load-handling device with a rear pluggable push-out drive,

FIG. 18 shows a perspective view of a load-handling device as a module,

FIG. 19 shows a perspective view of a racking system maintenance situation, and

FIG. 20 shows a simplified block diagram of the method according to the disclosure.

### DETAILED DESCRIPTION

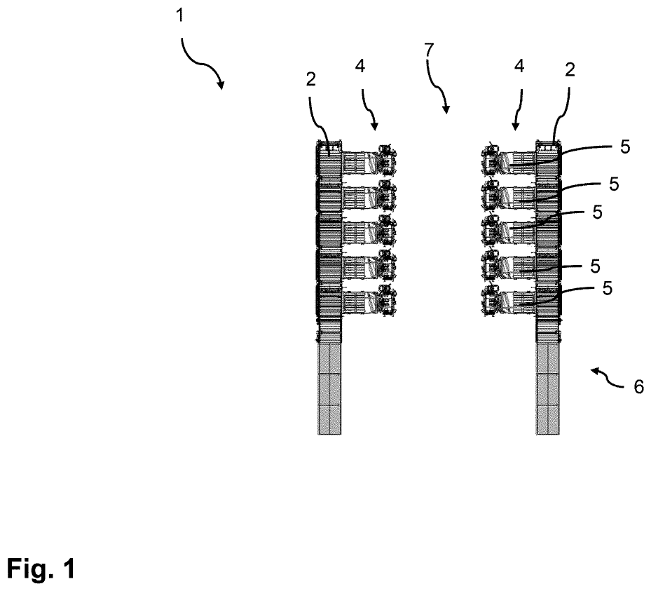

FIG. 1 shows a top view from above of a known racking system 1. The racking system 1 comprises a rack storage unit having two storage racks 2. A total of ten rack operating devices 5 are shown in front of or next to the storage racks 2, e.g., in two rows 4, at a distance from the storage rack 2. Further infeeding/outfeeding conveyor technology or rack structures 6 are indicated below in FIG. 1. FIG. 1 clearly shows that rows 4 of the rack operating devices 5 are at a considerable distance from the storage rack 2 and that rows 4 of the rack operating devices 5 take up rather much space in a rack aisle 7.

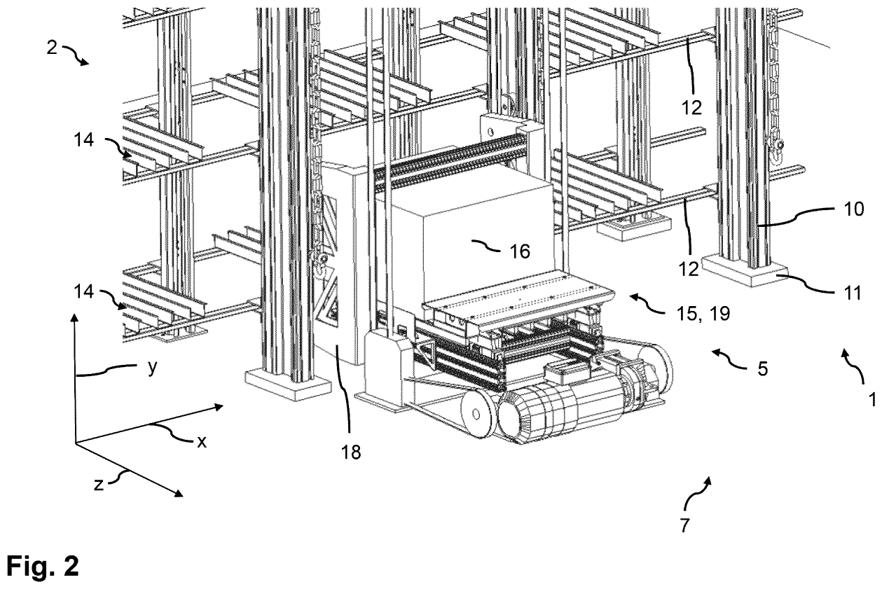

FIG. 2 shows an embodiment of a rack operating device 5 according to the disclosure and of the racking system 1 with masts 10 which are integrated into the outer rack uprights of the racking system 1. The masts 10 replace the uprights and are supported at the ground on concrete foundations 11. Alternatively, the masts could, for example, stand on preferably height-adjustable feet.

The illustrated storage rack 2 has cross struts 12 which are attached to or in front of the mast 10. Rack uprights 14 are arranged on the cross struts 12. Tines—not visible in FIG. 2—of a load-handling device 15 fit between the rack uprights, enabling the load-handling device 15 to grip from below many different conveyed and/or stored goods 16—shown as a cuboid in FIG. 2 as an example. The load-handling device 15, like the lifting cage 18, is part of the lifting unit 19. For other conveyed and/or storage items, a different load-handling device could be used.

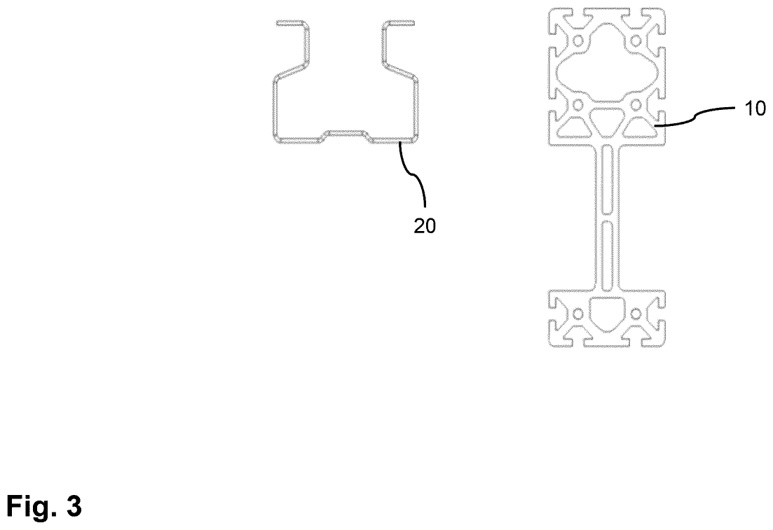

In FIG. 3, a conventional rack upright 20 is shown on the left and a mast 10 on the right in cross-section. The rack upright 10 is made of thin sheet steel. The mast has a larger and braced cross-section so that the mast 20 has a considerably larger geometrical moment of inertia.

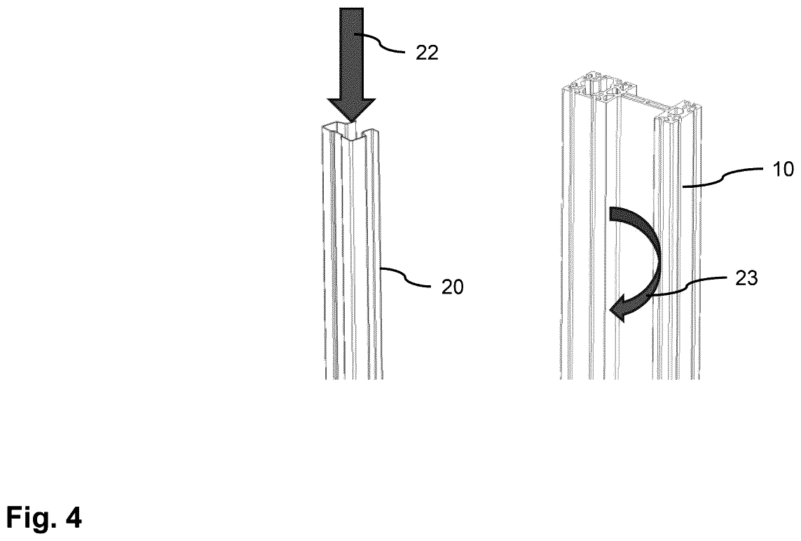

FIG. 4—on the left, the conventional rack upright 20 is again visible, and on the right, the mast 10—shows that the rack upright 20 is optimized for compressive loads 22 from above, while the mast 10 withstands bending stresses and loads due to torques 23 about the vertical y-axis significantly better than the rack upright 20, even when the mast 10 is made of aluminum.

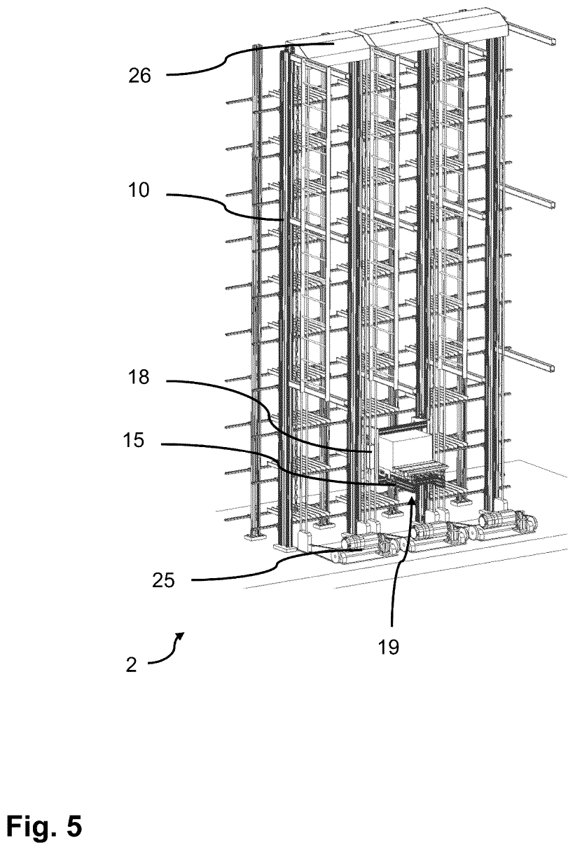

FIG. 5 shows the rack operating device 5 according to the disclosure and the storage rack 2 of the rack system 1 from FIG. 2. Drive devices 25 are arranged at the bottom of the masts 10. The lifting unit 19 with its lifting cage 18 and load-handling device 15 can be seen. Cross struts in the form of crossbeams 26 are arranged at the top of the masts 10. The crossbeams 26 connect the mast heads and further brace the storage rack 2.

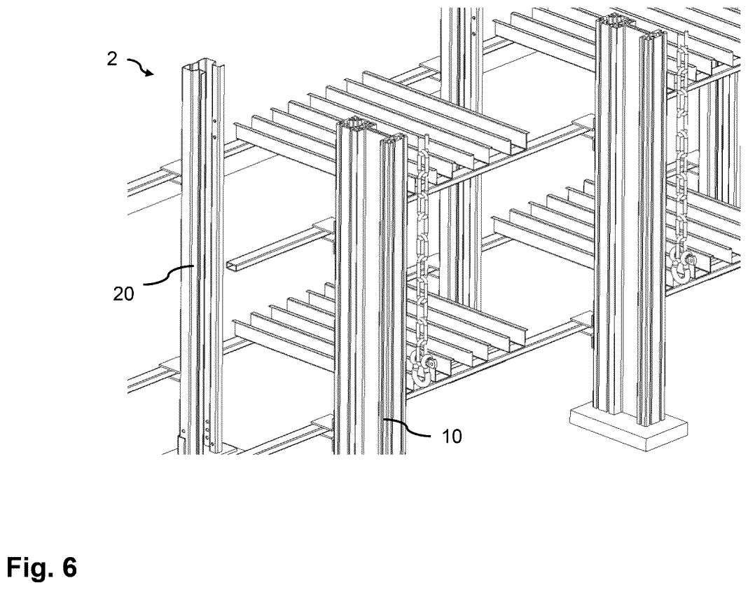

FIG. 6 shows—in particular in comparison to FIGS. 3 and 4—that the outer rack uprights are replaced by masts 10, whereas conventional rack uprights 20 are used inside the storage rack 2.

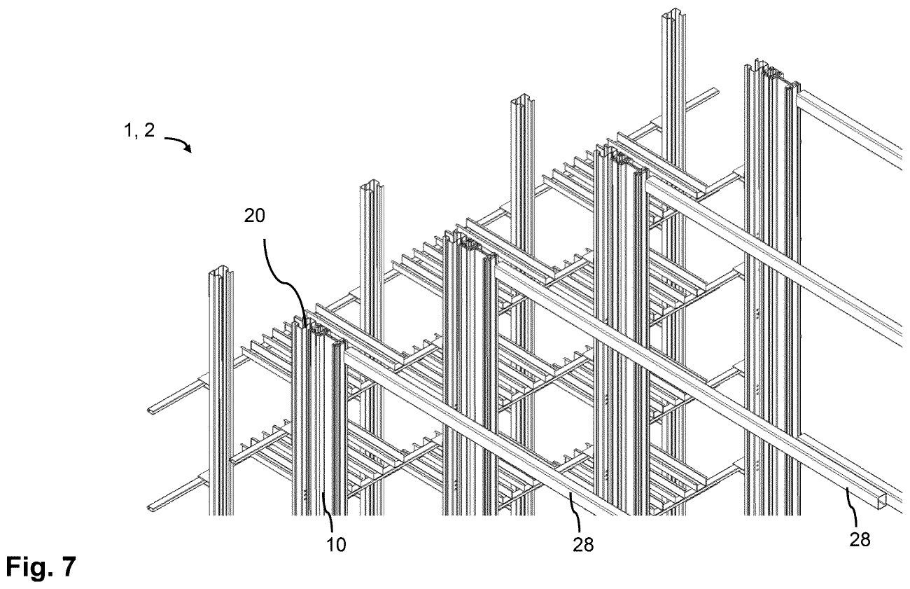

In contrast, FIG. 7 shows another embodiment. Here, the masts 10 are arranged directly on the conventional outer rack uprights 20 of the racking system 1. In addition, bracing elements 28 can be seen in FIG. 7. The bracing elements 28 each connect a mast 10 of the illustrated storage rack 2 to a mast of a second storage rack—not visible in FIG. 7—which is located opposite the storage rack 2, and therefore increase the stability and dimensional accuracy of the rack system 1.

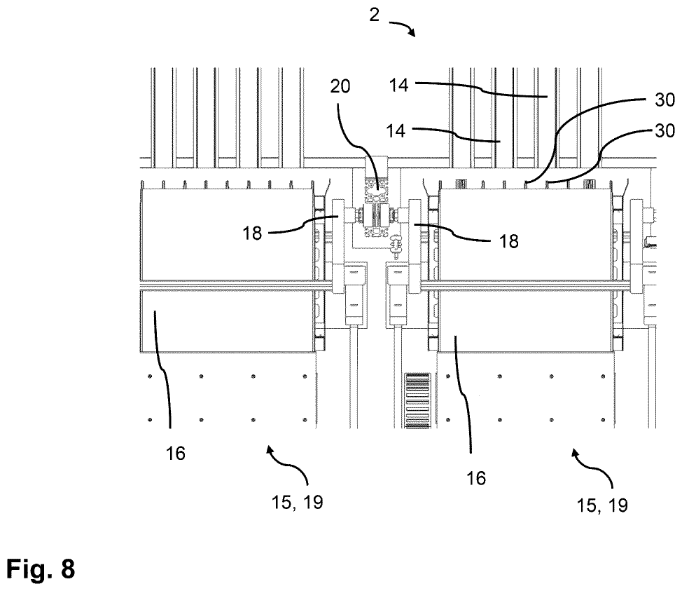

FIG. 8 shows two rack operating devices 5 from above, each with a lifting unit 19 with lifting cage 18 and load-handling device 15. The two load-handling devices 15 are each carrying one storage item 16. In addition, the ends of the tines 30 of the load-handling devices 15 can be seen, which fit into or between the rack uprights 14 of the storage rack 2. In FIG. 8, it can be seen particularly well that in this embodiment, the two lifting units 19 arranged next to each other on the left and right share the mast 10 arranged between them. The mast is therefore used on both sides by lifting units 19 with the lifting cages 18.

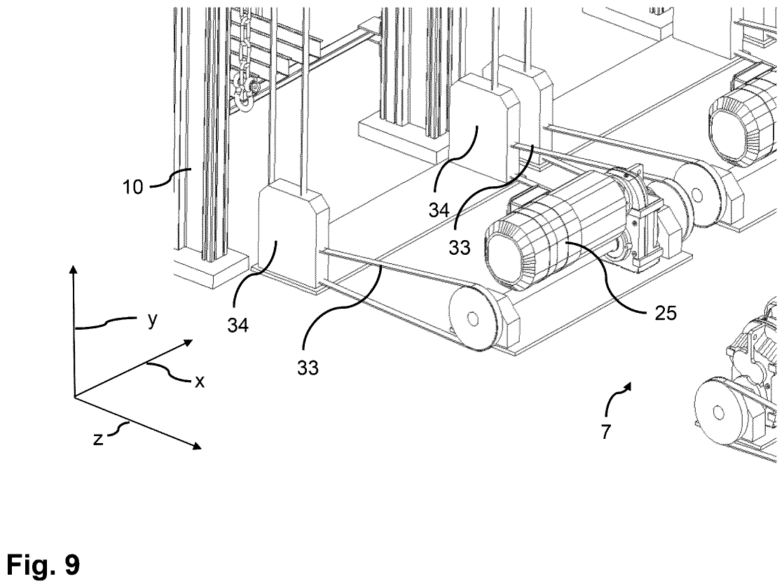

FIGS. 9 to 13 illustrate different variants and arrangements of drive devices 25 for the lifting unit 19. In the variant according to FIG. 9, the drive device 25 is located outside the storage rack 2 in the rack aisle 7. In other words, the drive device is located “behind” the lifting unit (not shown in FIG. 9). The drive devices 25 move lifting units up and down the masts 10 via two suspension means 33 extending in the vertical direction. The suspension means 33 are designed as belts. For this purpose, the suspension means 10 run over deflections 34, which are arranged essentially below the lifting unit.

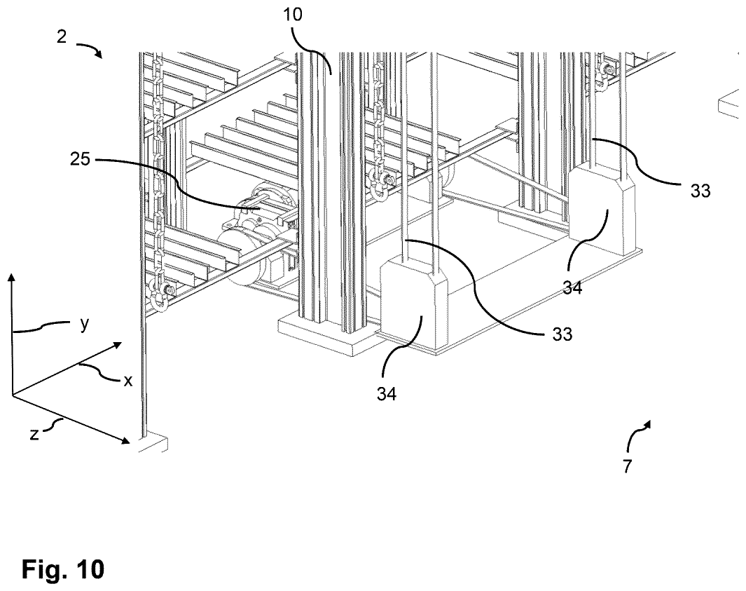

FIG. 10 shows a variant according to which the drive device 25 is arranged in the storage rack 2 in the z-direction or, in other words, in front of the lifting unit or below the storage rack. This means that the drive device 25 is less easily accessible, but the rack aisle 7 remains free.

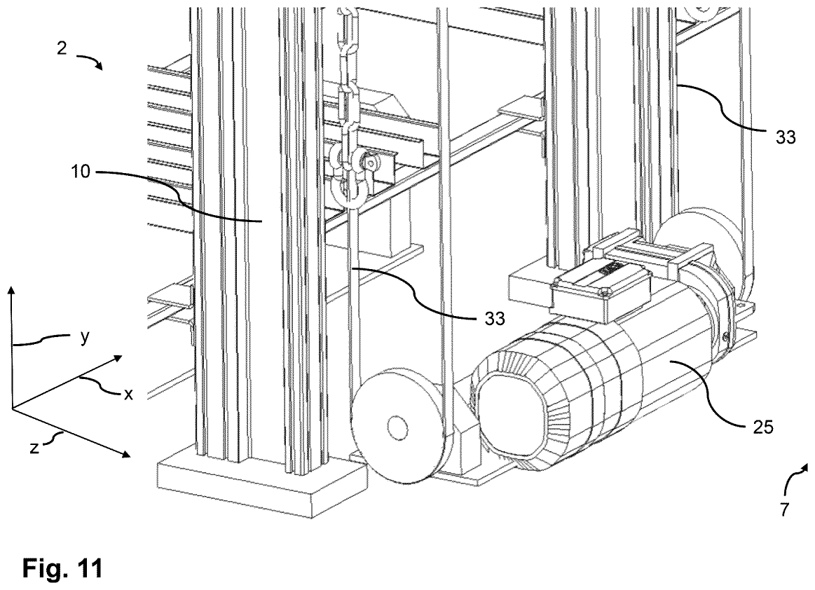

In the variant according to FIG. 11, the drive device 25 is located centrally below the lifting unit. Deflections are no longer required, but the lower approach dimension increases because the lifting unit can no longer move all the way down.

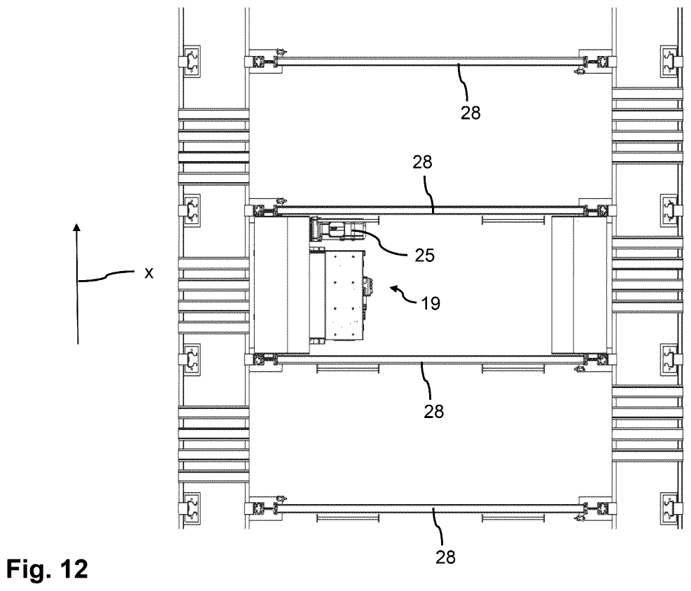

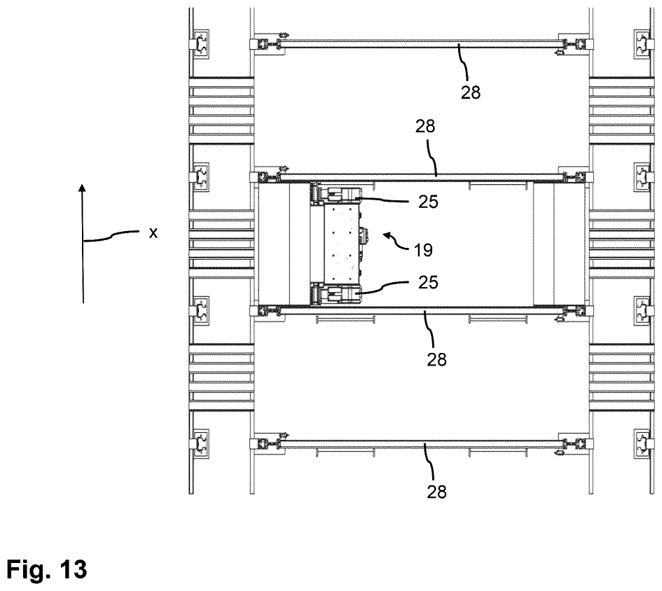

FIG. 12 shows a variant with the drive device 25 located laterally next to the lifting unit in the x-direction. In the embodiment according to FIG. 13, two drive devices 25 per lifting unit 19 are located on both sides next to the lifting unit 19 in the x-direction. FIGS. 12 and 13 also show the described optimized arrangement with at least three rack operating devices per storage rack in order to be able to optimally use the racking network and to optimally install the rack operating devices.

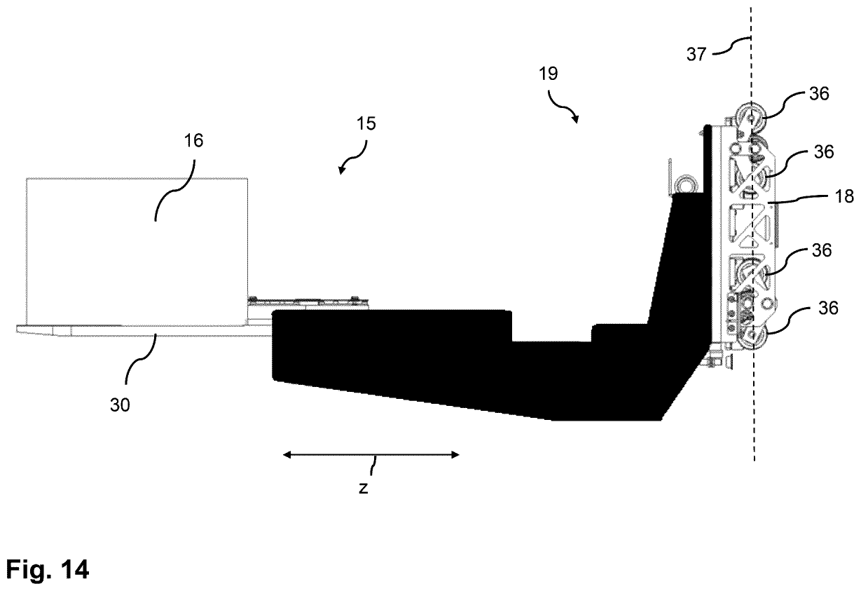

FIG. 14 shows a load-handling device 15 according to the prior art. The load-handling device 15 is in an extended state and carries a stored item 16. In this state, the load-handling device 15 can overcome a large distance in the z-direction so that the stored items 16 can be brought into or removed from a storage rack that is located at a distance from the mast—not shown in FIG. 14—on which the lifting cage 18 can be moved up and down with its rollers 36. The pivot point line 37 in the drawing therefore defines pivot points of the torques that act on the mast via the lifting unit 19.

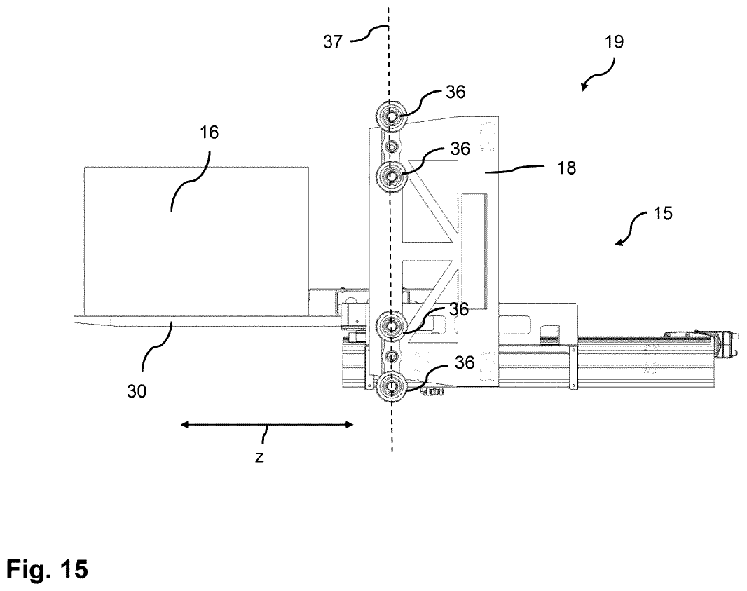

In contrast, FIG. 15 shows a load-handling device 15 for the rack operating device according to the disclosure, also in an extended state.

The load-handling device 15 is carrying a stored item 16. The distance in the z-direction that the load-handling device 15 must overcome so that the stored item 16 can be placed in a storage rack or removed therefrom is significantly reduced compared to the load-handling device according to FIG. 14. The drawn pivot point line 37 or the mast (not shown), on which the lifting cage 18 can be moved up and down with its rollers 36, are located approximately centrally in the z-direction with respect to the lifting unit 19. For this reason, the torques acting on the mast through the lifting unit 19 are considerably reduced so that a lightweight construction of the mechanics is possible. The travel distance in z-direction is essentially not less than in the case of the load-handling device according to FIG. 14. The pivot point of the load-handling device according to FIG. 15 is however in a different location. This reduces the distance between the pivot point and center of gravity of the load in the z-direction in the extended state.

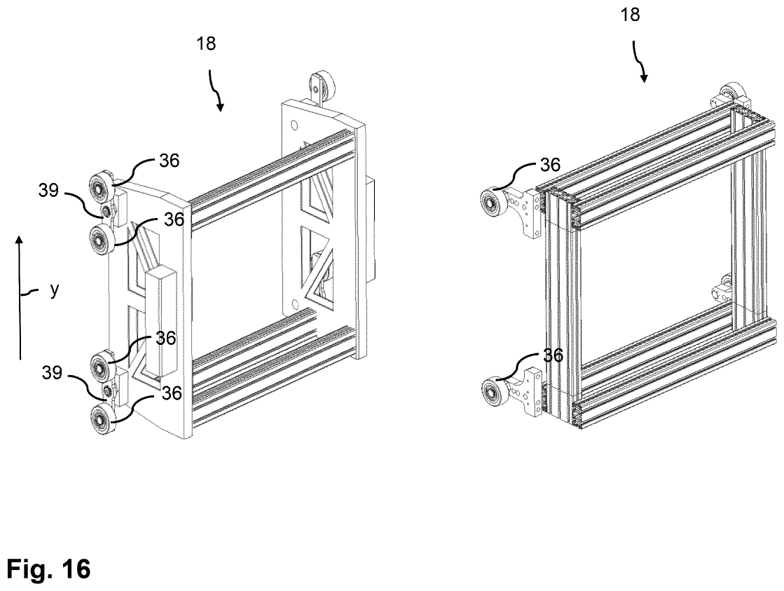

FIG. 16 shows two embodiments of lifting cages 18 for lifting units of the rack operating device according to the disclosure. The lifting cage 18 of the lifting unit according to FIG. 15 can be seen on the left. The left-hand lifting cage 18 has four rollers 36 on each side, which define a single degree of freedom for the lifting unit on a mast, namely in the vertical direction y. The four rollers 36 are arranged in pairs on two rockers 39 which in the case of large loads are used to compensate for bending loads and/or deformations.

In the right-hand lifting cage 18, not only the horizontal struts-running in the x-direction—are made of aluminum profiles but also the vertical parts running in the y-direction. This makes possible a weight reduction of up to 30%. In addition, the right-hand lifting cage 18 has no rockers and is designed for use with lower loads.

The lifting cages 18 can be provided with sensors for the horizontal axis as well as the vertical axis. In addition, a buffer for the crossing can be provided at the top/bottom of the load-handling device-alternatively or additionally, this is also possible at the mast head or floor.

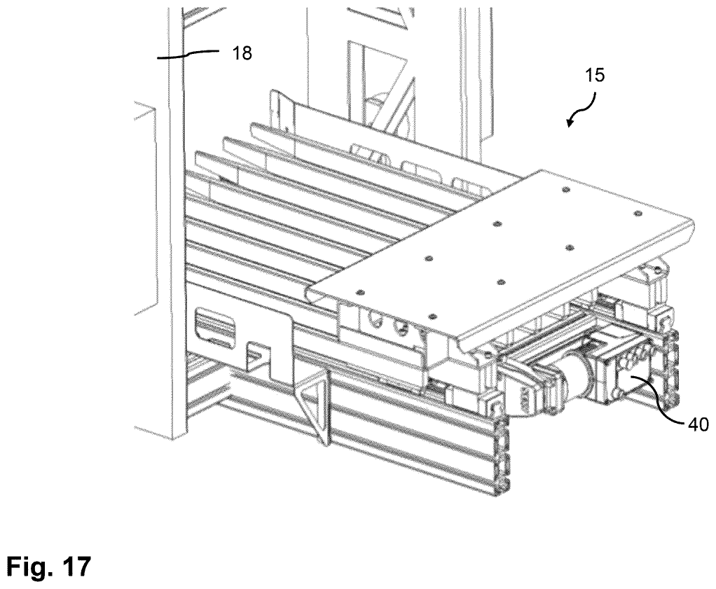

FIG. 17 shows a load-handling device 15 in a retracted state in a lifting cage 18. A removable push-out drive 40 is plugged in at the rear of the load-handling device 15.

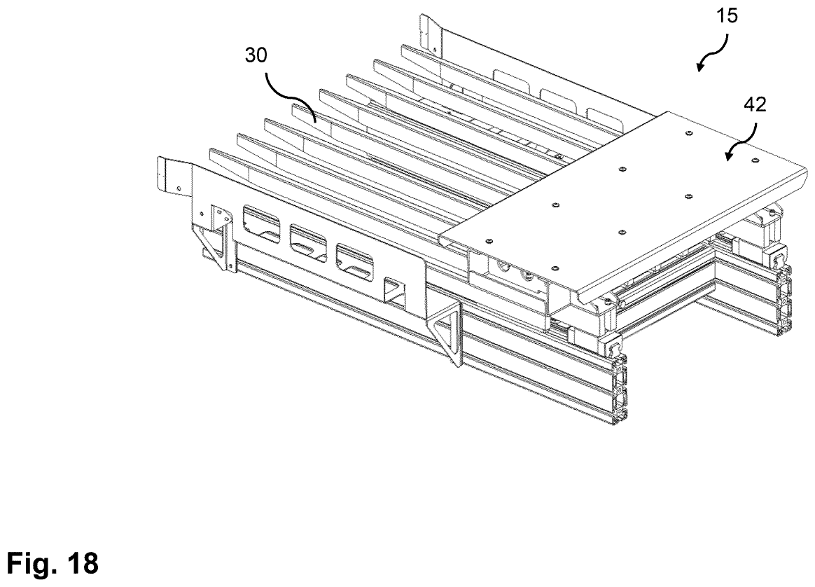

FIG. 18 shows a modular load-handling device 15 with integrated push-out drive. The tines 30 make it possible for the load-handling device 15 to grip different conveyed and stored items, in particular from below.

The load-handling device 15 has a tine receptacle 42. According to a preferred embodiment, the lifting cage and load-handling device 15 are of modular design such that there are various separation points. Cable connections for the sensor system, push-out drives, IO modules and/or energy chains can be designed to be pluggable. This means that the individual assemblies can be easily separated, maintained and/or replaced not only mechanically but also electrically if necessary. In this way, a component or module can be installed quickly, and the repair of defective parts can be carried out outside the operational racking system. This minimizes system downtime. This is particularly important when, for safety reasons, all rack operating devices in at least the relevant row or relevant storage rack must be stopped during access for maintenance purposes. Depending on requirements, smaller assemblies—for example, the tine receptacle 42—or larger assemblies—for example the load-handling device 15 including the tine receptacle 42—can be dismantled or replaced all together. Replacing the assembly is considerably less time-consuming than an in-situ repair. The removed assembly can be repaired outside the safety region while the racking system continues to operate.

When replacing the tine receptacle 42, the separation point preferably runs above the carriage of the linear guide of the load-handling device 15. The tine receptacle assembly 42 can be pulled out to the rear onto a maintenance trolley—not shown in FIG. 18. Electrical separation is not necessary since no electrical components are attached to the tine receptacle 42.

When replacing the entire load-handling device 15 including tine receptacle 42, the separation point is located between the lifting cage and the load-handling device 15. This assembly can also be placed on the maintenance trolley and then mechanically separated from the lifting cage. Alternatively, it is also conceivable to remove the assembly to the rear without a maintenance trolley.

When replacing the entire lifting cage including or excluding the load-handling device 15, the separation point can be provided between the suspension means and the lifting cage. The assembly to be replaced can be removed by relaxing the suspension means and undoing the attachment of the lifting cage to the suspension means. The rollers of the lifting cage are unscrewed, and the lifting cage can then be removed.

It is possible to remove the lifting cage with or without the load-handling device 15. Removal without the load-handling device 15 requires more steps, but the removed lifting cage alone is lighter and less bulky and therefore easier to handle.

The sensor system and IO modules can be attached to the lifting cage and/or the load-handling device 15.

If the sensor system is located on the load-handling device 15, any mechatronics on the lifting cage can be omitted. Parts such as the push-out drive, the sensor system, IO module and energy chain connection can be assigned to the load-handling device. In case of a defect, the entire load-handling device 15, including all electrical components, can be replaced. This can be a universal troubleshooting solution for all fault cases, which can be performed by operating personnel even without electrical knowledge because there are no electrical connections between the lifting cage and the load-handling device 15. It is possible to replace the load-handling device 15 faster and more easily than replacing the lifting cage. However, there is little space on the load-handling device 15 for attaching the sensor system. In addition, this makes the load-handling device 15 relatively expensive, which is particularly noticeable if additional load-handling devices 15 have to be kept in stock as spare parts.

If the sensor system is located on the lifting cage, the arrangement of the sensor system on the load-handling device 15 can be avoided. As a result, when replacing the load-handling device 15, only the cable of the push-out drive or of the load-handling device motor needs to be disconnected, provided that an IO module is not also attached to the load-handling device 15, but at most to the lifting cage. The sensor system of the vertical axis can be positioned particularly easily on the lifting cage. In addition, the load-handling device 15 becomes less expensive, especially as a spare part.

However, if electrical components on the load-handling device 15 are defective, the entire lifting cage must be replaced. This is relatively complex. Alternatively, a specific sensor can be replaced in a targeted manner. However, this involves more complex troubleshooting for appropriately qualified operating personnel. The targeted replacement of individual sensors regularly requires the disconnection of cable connections.

A combination is also conceivable in which, for example, the sensor system for the vertical axis is attached to the lifting cage and the sensor system for the horizontal axis is attached to the load-handling device 15.

Alternatively, the push-out drive or the load-handling device motor may not be located on the load-handling device 15. In this case, the load-handling device 15 can be moved externally by a motor on the lifting cage.

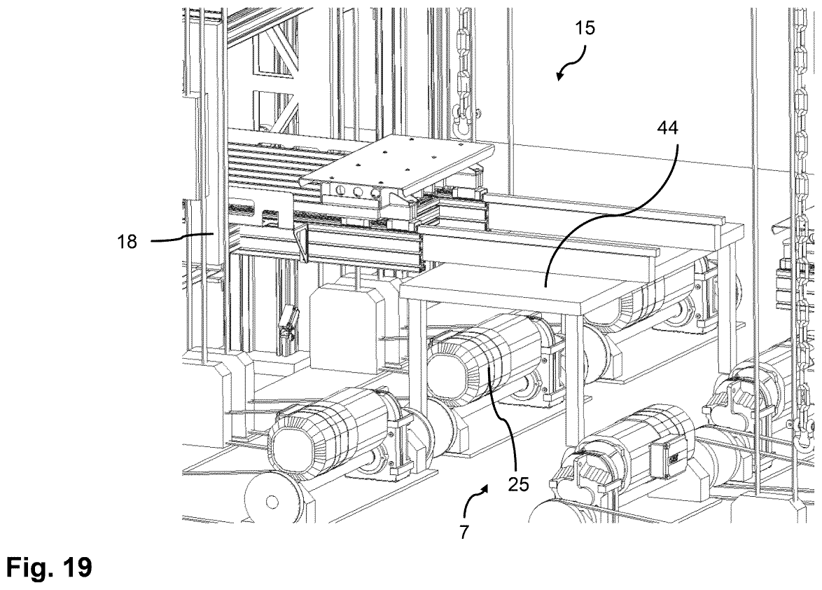

FIG. 19 shows a maintenance situation in which a maintenance trolley 44 is moved into the rack aisle 7. The load-handling device 15 can be removed from the lifting basket 18. The floor clearance of the rack aisle 7 achieved by the present disclosure allows the use of the maintenance trolley 44 as an aid with which the defective load-handling device 15 can be picked up and a new load-handling device can be introduced. This means that the load-handling device can be replaced more safely, more easily, and therefore more quickly than with conventional racking systems. Preferably, two maintenance trolleys 44 are present in a racking system. The defective load-handling device 15 can then be pushed onto the first trolley, while the second trolley is already available with the intact replacement load-handling device for exchange. This further minimizes overall downtime.

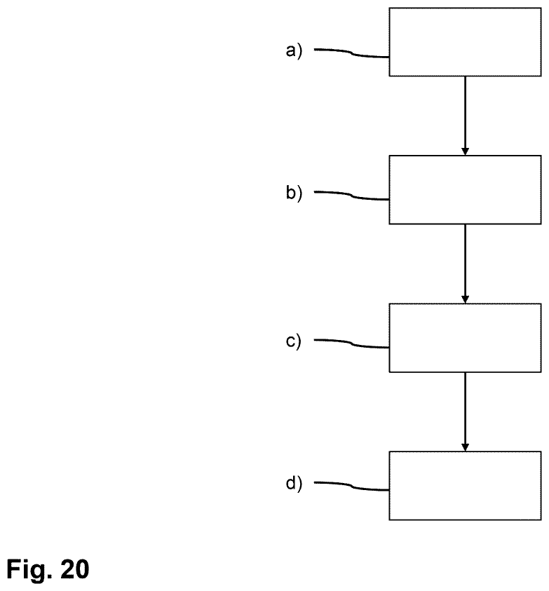

FIG. 20 shows a simplified block diagram of the method according to the disclosure. According to step a), at least one mast is first assembled with at least one storage rack during the construction of the rack storage system. In other words, the rack builder installs the masts of the rack operating devices directly during rack construction. Preferably, the mast head and other parts can also be installed in the process.

In step b), the rack builder can check the dimensional accuracy. According to step c), the lifting unit of the racking system and preferably the drive devices and/or load-handling devices are mounted. The drive unit and the deflection can also be mounted, provided that the two do not form a module.

Finally, in step d), the wiring and preferably the installation of the sensor system follows. The wiring can be simplified if individual elements are wired in advance as far as possible.

During wiring, an energy chain can preferably be arranged to the side of the load-handling device.

According to one embodiment, the energy chain can have a fixed point on the storage rack or on a bracing of the mast profiles, in particular at half the mast height. This results in a short energy chain with a short supply line.

Alternatively, a fixed point can be provided at the very top of the mast head. The supply lines then no longer have to be routed up each individual mast. Instead, the energy chain supply line can be run upwards centrally at one point on the storage rack and then be distributed to the individual fixed points at the top. An energy chain guide is not required since there is sufficient space. Eliminating the energy chain guide is also advantageous for reasons of space and reduces costs.

Alternatively, a busbar or a leaky waveguide or another method for energy and/or data transmission, for example optical, radio, etc., can be used for the “wiring”.

When placing the sensors, the lifting sensor system-vertical axis—can be stationary, and the sensor system of the load-handling device-horizontal axis—can be designed to travel along. This means that no switching plates are required on the rack operating unit. However, there is little installation space available on the mast for this since attachment options for the sensor system, cable ducts, IO modules, etc., are required.

Alternatively, the entire sensor system can be designed to be entrained. This results in a clear separation between storage rack/mechanics and automation/mechatronics. Mechanical modules such as the masts and mast heads are assigned to the storage rack and are already mounted with the storage rack. There is a low risk of damage from “rough” assembly by the rack builder since the number of modules is reduced to a minimum. Essentially, only profiles and deflections need to be mounted.

Mechatronic modules such as drive devices, push-out drives, lifting cages and load-handling devices are part of the automation. Compared to a mast, they are small and compact. This means that even in tight spaces, they can be introduced and mounted within a very short time after the rack has been completed. The mechatronic modules are therefore independent of the mast for assembly purposes. The energy chain is also removed or mounted independently of the mast.

The entire sensor system can be designed to be entrained if the sensor system is arranged centrally on the lifting cage and/or the load-handling device, including the sensor system for the vertical axis. In this case, the sensor system, cables and cable routing on the mast are eliminated completely or at least to a large extent. This is particularly important if both wide sides of the mast profile are occupied by lifting cages and therefore only the narrow front side and possibly the back of the mast profile could be used. Electrical components on the mast are only required when a stationary maintenance support is used. The stationary maintenance support can be designed as a bracket that can be extended by motor to automatically secure the lifting unit, in particular the load-handling device. The sensor system is better protected on the load-handling device since damage is avoided during erection of the mast. It is also impossible for the operating personnel to accidentally “kick off” the sensor system at leg height.

All sensors can be captured with a few IO modules or passive distributors on the lifting cage/load-handling device, including the push-out drive if required. This also means that the sensor cables are very short, for example only one meter instead of ten meters, and independent of the mast height. The cables from the IO module can be transmitted to a programmable logic controller via an energy chain or the alternative data transmission paths mentioned above.

Defective electrical components can be easily replaced by moving the load-handling device to working height. This means that the operating personnel do not have to climb up the storage rack to replace a sensor. In addition, if a cable is defective, only very short cables need to be replaced, which means that the length of the cable routing is reduced. However, switching plates on the mast/storage rack are required. With stationary maintenance supports, electrical components are still required on the mast.

After the assembly process is completed, commissioning can begin.

With regard to further advantageous embodiments of the device according to the disclosure, reference is made to the general part of the description and to the appended claims in order to avoid repetitions.

Finally, it is expressly pointed out that the exemplary embodiments described above of the device according to the disclosure serve only to explain the claimed teaching, but do not limit it to the exemplary embodiments.

### LIST OF REFERENCE SIGNS

1 Racking system
2 Storage rack
4 Rows
5 Rack operating device
6 Rack structures
7 Rack aisle
10 Mast
11 Concrete foundation
12 Cross struts
14 Compartment support
15 Load-handling device
16 Storage item
18 Lifting cage
19 Lifting unit
20 Conventional rack upright
22 Pressure load
23 Torque around the vertical y-axis
25 Drive device
26 Crossbeam at the mast head
28 Bracing
30 Tines
33 Suspension means
34 Deflections
36 Roller
37 Pivot point line
39 Rocker
40 Push-out drive
42 Tine receptacle
44 Maintenance trolley
a), b), c), d) Steps
x, y, z Directions in the coordinate system

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A rack operating device for a rack system for storage and retrieval, wherein the rack operating device has at least one mast extending in a vertical direction and a lifting unit movably arranged on the mast,
wherein the mast is arranged directly on a rack upright of the rack system and/or is integrated into the rack upright.

2. The rack operating device according to claim 1, wherein the lifting unit is arranged on two masts so as to be movable in the vertical direction.

3. The rack operating device according to claim 1, further comprising a drive device configured to move the lifting unit via at least one suspension means extending in the vertical direction on the mast.

4. The rack operating device according to claim 1, wherein the lifting unit is fixed to the mast with one degree of freedom in the vertical direction.

5. The rack operating device according to claim 1, wherein the lifting unit carries at least one load-handling device that is moveable in a horizontal direction in the lifting unit.

6. A racking system for storage and retrieval, comprising:
a rack storage unit with at least one storage rack, wherein the at least one storage rack has one or more compartments for stored items in one rack level or in a plurality of rack levels arranged one above the other; and
at least one rack operating device according to claim 1.

7. The racking system according to claim 6, wherein at least two masts are connected by at least one cross strut extending in the horizontal direction, wherein the cross strut simultaneously carries one or more rack uprights for one or more compartments of the racking system.

8. The racking system according to claim 6, wherein the mast heads of two masts arranged next to one another are connected to one another by a cross strut.

9. The racking system according to claim 6, wherein the rack storage unit has two opposing storage racks,
wherein a rack aisle is formed between the two opposing storage racks, and
wherein two masts of the two opposing storage racks opposite each other across the rack aisle are connected to each other by way of at least one bracing element.

10. A method for assembling a racking system according to claim 6, comprising:
a) mounting of at least one mast when constructing the rack storage unit with at least one storage rack;
b) checking dimensional accuracy and/or maintenance of tolerances;
c) mounting the lifting unit(s) of the racking system; and
d) wiring and installing the sensor system.

11. The method according to claim 10, further comprising mounting a drive device configured to move the lifting unit in a vertical direction.

12. The method according to claim 10, further comprising mounting a load-handling device that is moveable in a horizontal direction in the lifting unit.
